(19) United States
(12) Patent Application Publication
(10) Pub. No.: US 2011/0018443 A1
(43) Pub. Date: Jan. 27, 2011

(54) PLASMA GENERATING APPARATUS

(76) Inventors: Chwung-Shan KOU, Chungli Industrial Zone (TW); Yan-Ru Pan, Chungli Industrial Zone (TW); Shin-Hua Lin, Chungli Industrial Zone (TW); Teng-Wei Wang, Chungli Industrial Zone (TW); Yi-Hsiang Chan, Chungli Industrial Zone (TW); Jui-Yu Lin, Chungli Industrial Zone (TW)

Correspondence Address: HDLS Patent & Trademark Services, P.O. BOX 220746, CHANTILLY, VA, 20153-0746, US

(21) Appl. No.: 12/607,174

(22) Filed: Oct. 28, 2009

(30) Foreign Application Priority Data
Jul. 21, 2009 (TW) 098124529

(51) Int. Cl. H05H 1/24

(52) U.S. Cl. 315/111.21

(57) ABSTRACT

A plasma generating apparatus includes a chamber, a slow wave antenna and an electromagnetic wave generator. The chamber has an accommodating space. The slow wave antenna has a central conductive tube passing through the accommodating space, and a dielectric tube arranged around the central tube. The electromagnetic wave generator is used for coupling electromagnetic wave into the slow wave antenna. An electromagnetic wave transmitted by the electromagnetic wave generator can pass through the slow wave antenna and radiate into the accommodating space.

### BACKGROUND OF THE INVENTION

1. Field of the Invention

The present invention relates to a plasma generating apparatus, in particular to a plasma generating apparatus used for thin film depositing process or thin film etching process.

2. Description of Related Art

Plasma enhanced chemical vapor deposition (PECVD) is a kind of technique of forming a thin film. Generally speaking, PECVD technique can be divided into two main catalogs including radio frequency (RF) stimulated plasma and microwave stimulated plasma. RF plasma apparatus can be further divided into two catalogs including capacitively coupled plasma (CCP) and inductively coupled plasma (ICP). Microwave plasma apparatus was get more and more attention, for having advantages such as higher plasma density, higher electron ionization coefficient, having no electrode and simpler structure.

In order to get larger processing area, microwave plasma generating device can be designed into linear shape, which has a conductive antenna arranged in a vacuum chamber and a quartz tube arranged around the conductive antenna for isolating the conductive antenna. While operating, a microwave source is provided to transmit microwave energy into the vacuum chamber through the conductive antenna. Electromagnetic wave is radiated from the conductive antenna, and then the electromagnetic wave passes through the quartz tube and activates the specific gas in the vacuum chamber to generate plasma for depositing or etching. However, once the electromagnetic wave is radiated from a certain area of the conductive antenna, the microwave energy in the certain area will consequently decrease. Therefore, the farther the electromagnetic wave transmits along the conductive antenna, the weaker the microwave energy in the conductive antenna will be. The weaker microwave energy can activate lower density of plasma. Therefore, the plasma density is not identical everywhere along the conductive antenna.

In order to solve the abovementioned problem, U.S. Pat. No. 6,831,259 discloses a plasma generating apparatus having two microwave sources which individually inputs microwave energy via two opposite ends of the antenna in the vacuum chamber. A more uniform distribution of plasma density can obtain by linearly superposition of two microwaves generated by the two microwave sources. However, such a design including two electromagnetic wave generators needs well and precisely control so as to generate stable plasma. It relies on whether or not the optimized operating condition can be figured out. Otherwise, it easily happens that the distribution of plasma presents non-uniform.

### SUMMARY OF THE INVENTION

The object of the present invention is to provide a plasma generating apparatus having better plasma uniformity.

In order to achieve aforementioned purpose, the present invention provides a plasma generating apparatus including a chamber, a slow wave antenna and an electromagnetic wave generator. The chamber has an accommodating space. The slow wave antenna has a central conductive tube passing through the accommodating space, and a dielectric tube arranged around the central tube. The electromagnetic wave generator is used for coupling electromagnetic wave into the slow wave antenna. An electromagnetic wave transmitted by the electromagnetic wave generator can pass through the slow wave antenna and radiate into the accommodating space.

The present invention utilizes the slow wave antenna to transmit microwave so that the energy of the microwave can be axially transmitted along the dielectric tube with nearly no attenuation and can induce surface wave. The phase velocity of the surface wave is slower than light speed, thus the surface wave is slow wave which can transmit with nearly no attenuation and then can radically couple to the plasma area in the accommodating space. Therefore, large area and uniformly plasma can be generated in the chamber. Utilizing the slow wave antenna and only one electromagnetic wave generator, the plasma generating apparatus can generates uniform plasma. Comparing to the prior art, the plasma generating apparatus has advantages of lower cost of electromagnetic wave generator, lower energy consumption and better plasma uniformity.

### BRIEF DESCRIPTION OF THE DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a perspective view of a plasma generating apparatus according to a first embodiment of the present invention;

FIG. 2 is a cross sectional view of the plasma generating apparatus;

FIG. 3 is a perspective view of a slow wave antenna of the plasma generating apparatus;

FIG. 4 is perspective view of another slow wave antenna;

FIG. 5 is a perspective view of another embodiment of the plasma generating apparatus;

FIG. 6 is a perspective view of another embodiment of the plasma generating apparatus;

FIG. 7 is a perspective view of a plasma generating apparatus according to a second embodiment of the present invention;

FIG. 8 is a cross sectional view of the plasma generating apparatus;

FIG. 9 is a dispersion relation chart of the slow wave antenna;

FIG. 10 and FIG. 11 are radical distribution charts of electromagnetic wave of the slow wave antenna;

FIG. 12 is an air pressure variation chart of the plasma density generated by the slow wave antenna;

FIG. 13 is a radical distribution chart of plasma density of the slow wave antenna;

FIG. 14 is a axial distribution chart of plasma density of the slow wave antenna; and

FIG. 15 is another axial distribution chart of plasma density of the slow wave antenna.

### DETAILED DESCRIPTION OF THE INVENTION

A detailed description of the present invention will be made with reference to the accompanying drawings.

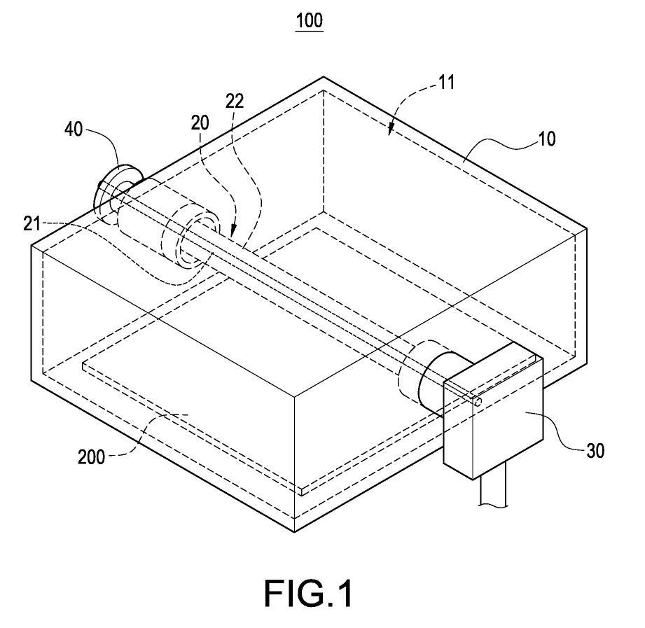

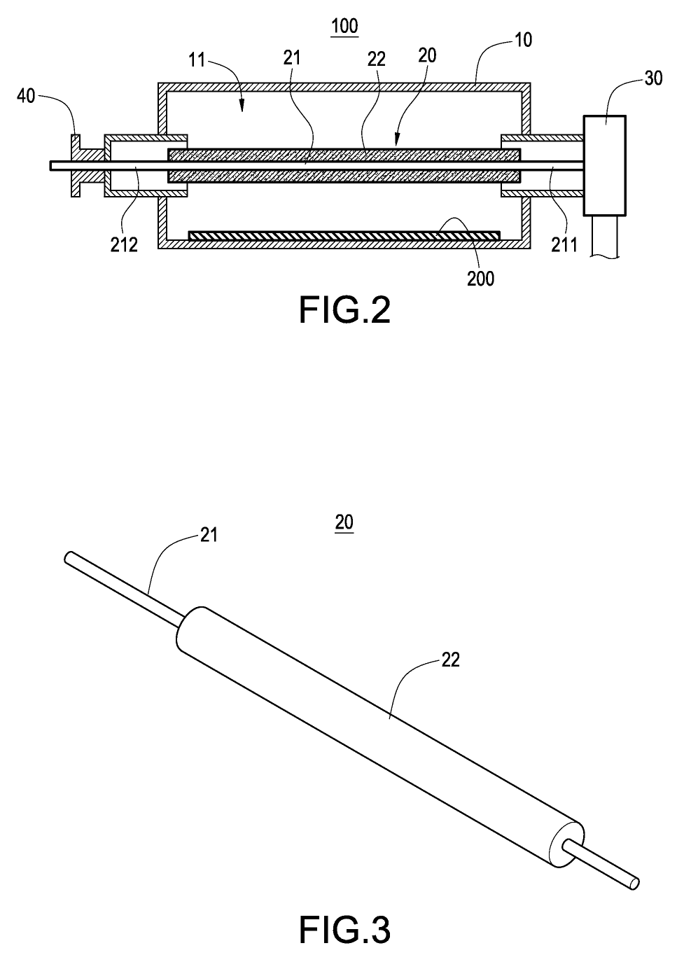

FIG. 1 and FIG. 2 show a plasma generating apparatus according to a first embodiment of the present invention. The plasma generating apparatus 100 is used for performing thin film depositing process or thin film etching process for a substrate. The plasma generating apparatus 100 mainly includes a chamber 10, a slow wave antenna 20, and an electromagnetic wave generator 30.

The chamber 10 is of rectangular shaped. The chamber 10 can be made of metal material, but not limited thereto. The chamber 10 has an accommodating space 11 for arranging a substrate 200.

The slow wave antenna 20 is substantially arranged in the accommodating space 11. The slow wave antenna 20 has a central conductive tube 21 passing through the accommodating space 11, and a dielectric tube 22 arranged around the central tube 21. The dielectric tube 22 is tightly fit around the central tube 21. The central conductive tube 21 has two opposite ends protrude out of the chamber 10. The central conductive tube 21 is made of metal conductor, non-metal conductor or metal oxide conductor. The wall thickness of the central conductive tube 21 is greater than the skin depth of the electromagnetic wave. As FIG. 2 and FIG. 3 show, the dielectric tube 22 has uniform wall thickness along its length direction. The dielectric tube 22 is made of metal compound, non-metal compound or polymer compound. For example, the dielectric tube 22 can be made of PTFE material. Preferable, the dielectric constant of the dielectric tube 22 is between 2 and 10.

The electromagnetic wave generator 30 is used for coupling electromagnetic wave into an end 211 of the central conductive tube 21 of the slow wave antenna 20. The electromagnetic wave generator 30 generates 2.45 GHz microwave, and the frequency of the microwave is not limited thereto. The microwave generated by the electromagnetic wave generator 30 transmits from the central conductive tube 21 into dielectric tube 22 and induces surface wave on the outer surface of the dielectric tube 22. The phase velocity of the surface wave on the outer surface of the dielectric tube 22 is slow than light speed. Thus, the surface wave can be classified as slow wave. The slow wave is not easy to decay while transmitting so that the microwave energy can transmit along the slow wave antenna 20 without attenuation and can radial couple the electromagnetic wave into plasma area of the accommodating space 11. Such a plasma area has uniform plasma density.

Besides, the plasma generating apparatus 100 further includes a resonance adjusting member 40 electrically connected to the other end 212 of the central conductive tube 21. The resonance adjusting member 40 is used for adjusting microwave to form resonance so that better plasma uniformity could obtain.

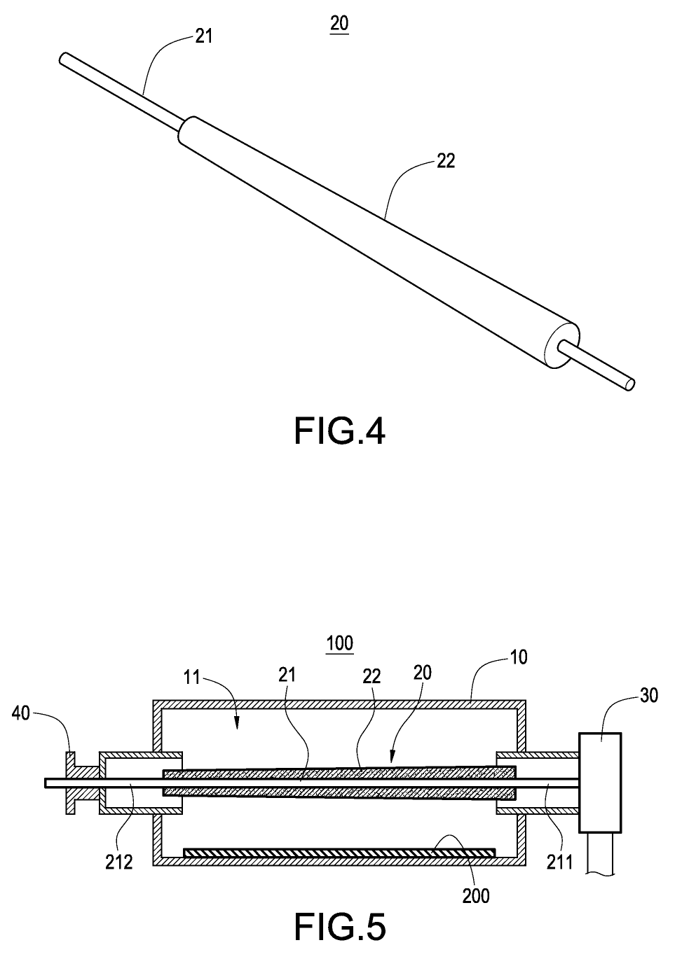

In order to further decrease the attenuation of the microwave energy in the slow wave antenna, FIG. 4 shows another embodiment of the slow wave antenna 20. The dielectric tube 22 of the slow wave antenna 20 has non-uniform wall thickness along its length direction. As FIG. 5 shows, the wall thickness of the dielectric tube 22 gradually decreases from its near end to its far end with respect to the electromagnetic wave generator 30. Thinner wall of dielectric tube 22 emits stronger radiation, thus compensates attenuation of the electromagnetic wave in the slow wave antenna 20 while transmitting.

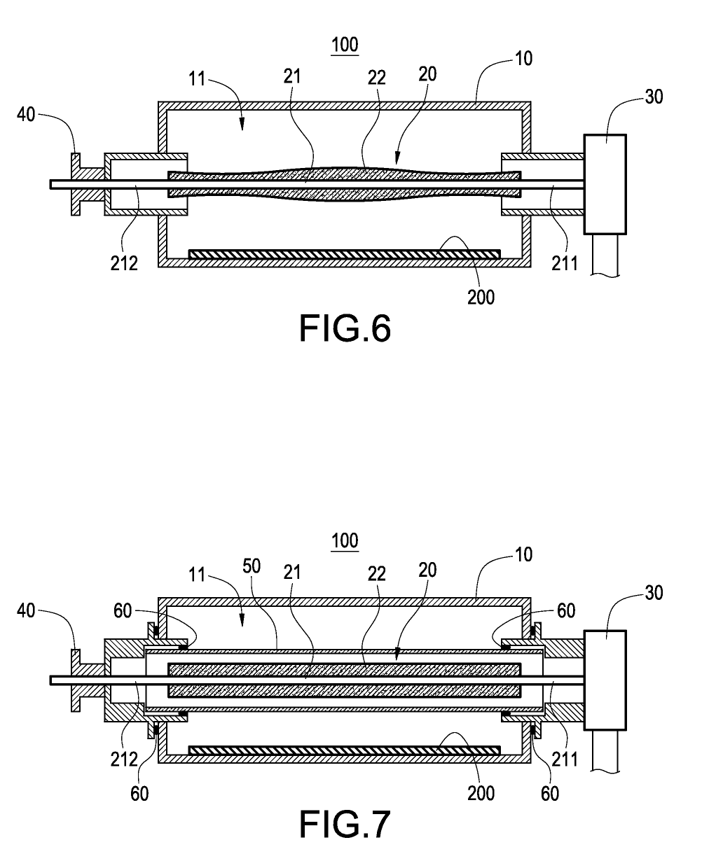

Besides, in order to fine tune the plasma density everywhere in the chamber 10, the dielectric tube 22 can be design to non-uniform wall thickness along its length direction. For example, as FIG. 6 shows, a wave-shaped dielectric tube 22 can be used, in practical use, not limited thereto.

FIG. 7 shows, a plasma generating apparatus 100 according to a second embodiment of the present invention, which is substantially the same as the first embodiment. The difference between them is this embodiment further includes an isolating tube 50 arranged around the slow wave antenna. The isolating tube 50 can be made of glass or quartz. The two ends of the isolating tube 50 respectively extend to the chamber 10 so as to hermetically isolate the slow wave antenna 20 through rubber o-rings 60. Isolated in the isolating tube 50, the slow wave antenna 20 can avoid being polluted such as bombarded by charged particle or attached by reactants. Thus the lifetime of the slow wave antenna 20 can be increased.

Besides, since the high temperature caused while operating by the slow wave antenna 20 affects transmitting efficiency of the microwave and even affects the uniformity of plasma density. Cooling fluid can be arranged between the slow wave antenna 20 and the isolating tube 50 to cool down the slow wave antenna 20 while operating. Also, cooling fluid can be arranged inside the central conductive tube 21.

According to Ph.D. thesis of one of the inventor, Pan, Research of microwave excited coaxial slow wave structure surface wave plasma source. (Physics department, TsingHua University, ROC), theoretical analysis of the abovementioned slow wave antenna is described below.

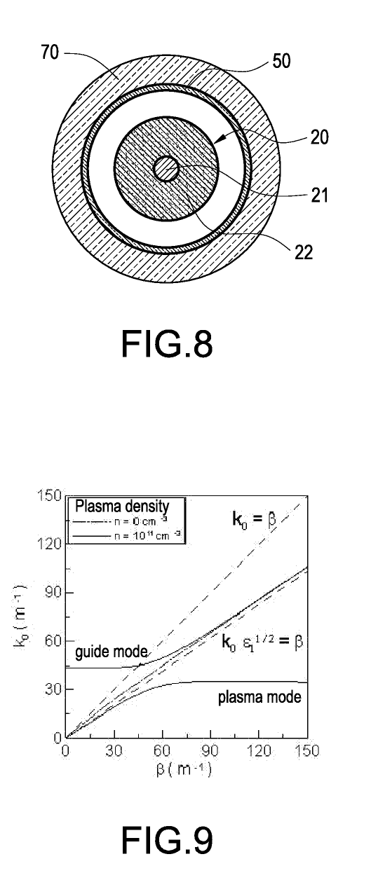

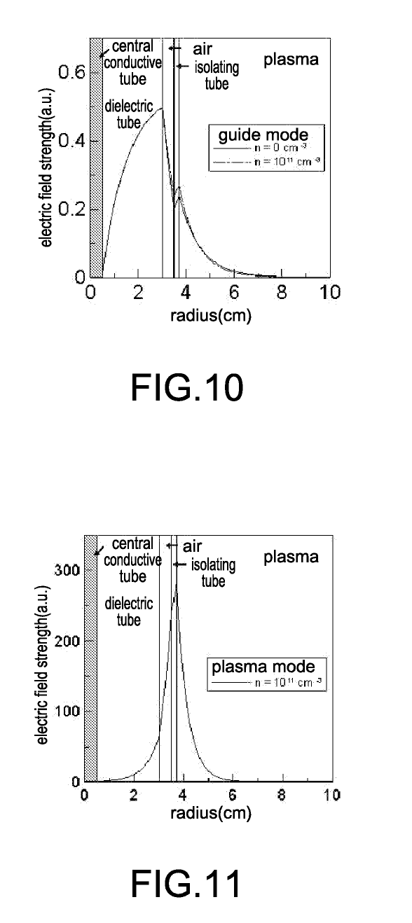

As FIG. 8 shows, a cross-sectional view of a slow wave antenna and a isolating tube in a plasma environment. Air is filled between the slow wave antenna 20 and the isolating tube 50. Outside the isolating tube 50 is plasma 70. The electromagnetic wave transmitting behavior in FIG. 8 can be explained by color dispersion relation in the FIG. 9. Two situations whose plasma densities (n) are 0 and 10¹¹ cm⁻³ are represented in FIG. 9. When plasma density is 0, electromagnetic wave can only transmit by single mode, which is similar to surface wave in grounding medium conductive plate. Electromagnetic wave is bounded in the medium and transmits in slow wave form, then attenuates after leaving the dielectric tube 22. Such a phenomenon is called guide mode.

In low frequency range, because of longer wavelength of electromagnetic wave, the electromagnetic field bounding ability of dielectric tube 22 is weaker. The phase velocity of electromagnetic wave is approximate to the transmitting speed of the electromagnetic wave in free space, which is the light speed (k0=β). In high frequency range, because of shorter wavelength of electromagnetic wave, the electromagnetic field bounding ability of dielectric tube 22 is stronger, almost all electromagnetic field is bounded in the dielectric tube 22. Hence, the phase velocity is substantially decided by the dielectric constant of the dielectric tube 22, k0∈11/2=β. When plasma is being generated, the plasma density is 10¹¹ cm⁻³, the electromagnetic wave transmits by dual mode instead of single mode.

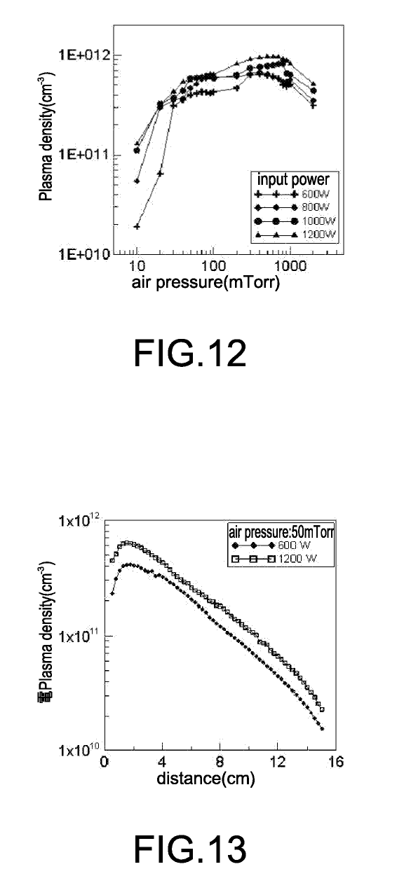

FIG. 11 and FIG. 12 show the radial distribution of electromagnetic field and the difference between single mode and dual mode. As FIG. 11 shows, the presence of plasma only slightly affects the distribution of electromagnetic field. In guide mode, because almost all electromagnetic field is bounded in the dielectric medium, the presence of plasma only generates small distribution such that the presence of plasma almost does not affect the distribution of electromagnetic field.

Therefore, it can be sure that the solution of high pass band is transformed from guide mode. And the presence of plasma makes guide mode have fast wave solution in low frequency range and a cut-off frequency is present. While ω<ωp, the dielectric constant of plasma is negative which makes plasma seems to form a reflective surface like a metal plate with respect to electromagnetic wave. Thus the boundary condition in infinity does not need seriously stand, such that the structure is similar to the TM₀₁ mode in coaxial wave guide.

As FIG. 11 shows, the strongest electromagnetic field is located in the discontinued interface between plasma and insolating tube. And this mode is only present while plasma is generating, and it can be sure that such is a plasma mode in plasma surface wave type.

Further, as FIG. 11 shows, under this mode the transmittance of electromagnetic wave has an upper limit frequency. While surface wave of plasma is generating and the plasma frequency is fixed, the transmitting frequency has an upper limit ω_{P}>\sqrt{1+∈_{d}ω}, the coefficient of

$$\frac{{ω}_{p}}{ω}$$

in critical condition depends on dispersion relation or depends on structure of plasma surface wave. When plasma density is 10¹¹ cm⁻³, the coefficient of the structure

$$\frac{{ω}_{p}}{ω}$$

is approximate or equal to 1.6785.

The abovementioned theoretical analysis proves the slow wave antenna can induce plasma surface wave. Also, it proves the main energy of electromagnetic wave in the slow wave antenna is bounded and transmits in the surface of dielectric tube. Such a phenomenon is beneficial to form a long-distance and uniform distribution of electromagnetic wave energy, and is beneficial to be used as linear plasma source.

Two practical examples are introduced below to detailed describe the present invention.

The first example, the length of the slow wave antenna is 45 cm, which has 0.6 cm outer radius conductive tube and 5 cm outer radius dielectric tube. The dielectric tube is made of PTFE. The slow wave antenna is arranged in a 7 cm inner radius isolating tube. The isolating tube is made of quartz.

As FIG. 12 shows, with different microwave input power, the density of plasma generated by the slow wave antenna in the chamber of plasma generating apparatus varies with the air pressure in the chamber. Plasma density increases as the input power increases. When input power is 1200 W, the maximum plasma density can reach 10¹² cm⁻³. High density plasma is indeed obtained.

FIG. 13 shows a radial distribution of the slow wave antenna. Under lower air pressure, the distribution of plasma density will slowly raise and then gradually drop off. The plasma density around the surface of quartz tube is higher.

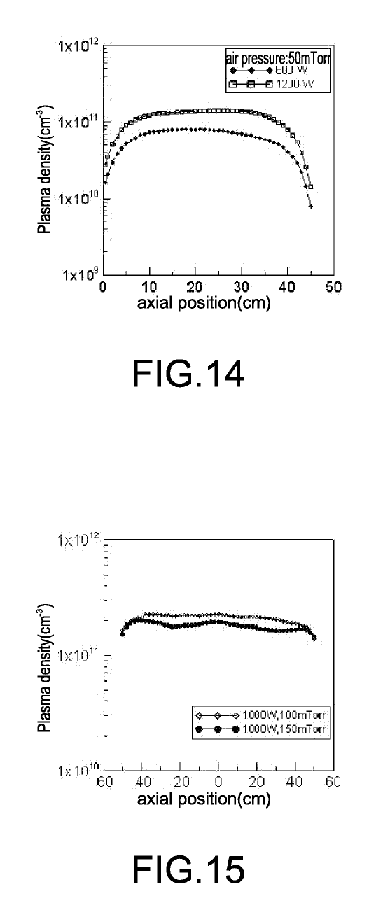

FIG. 14 shows an axial distribution of the slow wave antenna. In the middle 25 cm range of the slow wave antenna, the uniformity of plasma density can keep between ±10%. When input power is 600 W, the uniformity In the middle 25 cm range can even keep between ±5%.

The second example, the length of slow wave antenna is increased to 100 cm. As FIG. 15 shows, the axial distribution of plasma density of the slow wave antenna also presents good uniformity and symmetry.

Therefore, the present invention utilized the slow wave antenna 20 to transmit microwave so that the energy of the microwave can be axially transmitted along the dielectric tube 22 with nearly no attenuation, and then radically couple to the plasma area in the accommodating space 11. Uniformly plasma can be generated in the chamber 10.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A plasma generating apparatus, comprising:
a chamber having an accommodating space;
a slow wave antenna having a central conductive tube passing through the accommodating space, and a dielectric tube arranged around the central tube; and
an electromagnetic wave generator used for coupling electromagnetic wave into the slow wave antenna,
whereby an electromagnetic wave transmitted by the electromagnetic wave generator passes through the slow wave antenna and radiates into the accommodating space.

2. The plasma generating apparatus according to claim 1, wherein the central conductive tube is made of metal conductor, non-metal conductor or metal oxide conductor.

3. The plasma generating apparatus according to claim 1, wherein the wall thickness of the central conductive tube is greater than the skin depth of the electromagnetic wave.

4. The plasma generating apparatus according to claim 1, wherein the dielectric tube is tightly fit around the central tube.

5. The plasma generating apparatus according to claim 1, wherein the dielectric tube is made of metal compound, non-metal compound or polymer compound.

6. The plasma generating apparatus according to claim 1, wherein the dielectric constant of the dielectric tube is between 2 and 10.

7. The plasma generating apparatus according to claim 1, wherein the dielectric tube has uniform wall thickness along its length direction.

8. The plasma generating apparatus according to claim 1, wherein the dielectric tube has non-uniform wall thickness along its length direction.

9. The plasma generating apparatus according to claim 1, wherein the wall thickness of the dielectric tube gradually decreases from the near end to the far end with respect to the electromagnetic wave generator.

10. The plasma generating apparatus according to claim 1, wherein the electromagnetic wave includes microwave.

11. The plasma generating apparatus according to claim 1, further comprising an isolating tube arranged around the slow wave antenna.

12. The plasma generating apparatus according to claim 11, wherein the two ends of the isolating tube respectively extend to the chamber so as to hermetically isolate the slow wave antenna.

13. The plasma generating apparatus according to claim 11, further comprising cooling fluid arranged between the slow wave antenna and the isolating tube and cooling fluid arranged inside the central conductive tube.

14. The plasma generating apparatus according to claim 1, further comprising a resonance adjusting member electrically connected to the central conductive tube.
